(19) United States
(12) Patent Application Publication
(10) Pub. No.: US 2022/0332516 A1
(43) Pub. Date: Oct. 20, 2022

(54) CARRYBACK ASSESSMENT TRAY

(71) Applicant: Flexible Steel Lacing Company, Downers Grove, IL (US)

(72) Inventors: Brett E. DeVries, Comstock Park, MI (US); David A. Moelker, Zeeland, MI (US); Christopher Bias, Sumerco, WV (US); David Foreman, Boerne, TX (US)

(21) Appl. No.: 17/724,480

(22) Filed: Apr. 19, 2022

Related U.S. Application Data
(60) Provisional application No. 63/176,857, filed on Apr. 19, 2021.

(51) Int. Cl. B65G 45/10; B65G 43/08

(52) U.S. Cl. CPC B65G 45/10; B65G 43/08; B65G 2203/0208

(57) ABSTRACT

A carryback material collection system is provided for assessing carryback material received from a conveyor belt. The carryback material collection system includes a tray positionable below the conveyor belt for receiving carryback material from the conveyor belt. The carryback material collection system further includes at least one sensor for detecting carryback material received in the tray. The carryback material collection system further includes a processing unit communicatively coupled with the at least one sensor for conveying information indicative of the carryback material detected by the at least one sensor. The carryback material collection system further includes a tray actuator that is operatively coupled to the tray to move the tray between a collection orientation to receive carryback material from the conveyor belt and a discharge orientation to discharge the carryback material from the tray.

### CROSS-REFERENCE TO RELATED APPLICATION

This application claims the benefit of U.S. Provisional Patent Application No. 63/176,857, filed Apr. 19, 2021, entitled CARRYBACK ASSESSMENT TRAY, which is hereby incorporated by reference in its entirety.

### FIELD

This disclosure relates to conveyor systems and, more specifically, to monitoring carryback of a conveyor system.

### BACKGROUND

Conveyor systems are utilized to transport materials or objects from one position to another. One type of conveyor system is a conveyor belt system which may include a series of rollers and a conveyor belt arranged to travel thereover in a downstream belt travel direction and path. Conveyor belt systems may be used to transport different conveyed materials such as coal or aggregate.

During use, residue from the conveyed material can build up on a conveyor belt. The residue may include small particles and/or liquids that stick to the belt such that the residue remains in contact with the conveyor belt surface after the rest of the conveyed material is discharged from the belt.

Conveyor belt cleaners are used to remove such residue and debris as the conveyor belt moves along the travel path. In many instances, however, such conveyor belt cleaners may not remove all residue. For example, an improperly installed or misaligned belt cleaner may remove some but not all residue from the belt. Even properly installed and aligned belt cleaners have belt scraper elements that may wear down over time, resulting in increasingly more residue and debris traveling past the belt cleaner. Such accumulating residue and debris may be referred to as carryback.

Carryback may negatively affect performance of a conveyor belt. For example, carryback may build up on the belt, may create an undue amount of airborne dust, or may eventually fall from the belt, accumulating in piles under the belt. Carryback accumulating unevenly on the belt may cause belt mistracking which may result in material spillage and off-center loading of conveyor rollers and the bearings therefor. Conveyor belt mistracking can lead to shortened belt-life, increased labor costs, and unscheduled downtime. Furthermore, cleanup of carryback can be labor- and equipment-intensive, often requiring equipment or services such as loaders and vacuum trucks.

Carryback may be monitored to determine the condition or alignment of an upstream belt cleaner. Known monitoring methods for monitoring carryback include manually scraping carryback material from a stopped belt with a knife and manually weighing the carryback. This can be a labor-intensive process and may require the belt to be stopped before scraping and collecting the carryback. Other known methods for monitoring carryback are described in U.S. Pat. No. 4,611,498, which discloses positioning a scraping element in a collection receptacle adjacent a belt for a duration of time while under the direct observation and manual control of an operator. The scraping element scrapes only a portion of the width of the belt (e.g., one inch), and may be controlled to move back and forth across the width of the belt. To assess carryback, the receptacle is manually removed from its support structure, and any carryback within the receptacle is manually removed for manual weighing. The weight measurements are compiled into an overall efficiency rating to gauge contamination carried back during the return run of the belt. The receptacle is then cleaned and reinstalled for obtaining the next test sample. This is a manual and labor-intensive process.

In another known method, a scraping element having a width less than the width of the belt is positioned against the belt. Carryback scrapings are then captured in a separate container attached to a support structure below the scraping element. The container is then manual removed from the support structure and weighed. The weight versus collection time is assumed to be the average carryback per width for the entire belt. This method often produces inaccurate results and requires manual intervention and sample weighing.

### BRIEF DESCRIPTION OF THE DRAWINGS

FIG. 1 is a perspective view of a carryback collector including a collecting tray mounted under the return run of a conveyor belt with the tray in a collection position.

FIG. 2 is another perspective view of the carryback collector showing the scraper blade above the collecting tray.

FIG. 3 is a side elevation view of the carryback collector showing a tray actuator for shifting the tray.

FIG. 4 is a front elevation view of the carryback collector showing the tray in a standby or discharge position.

FIG. 4A is an enlarged front elevation view of a side frame of the carryback collector showing a load cell for measuring a weight of carryback material received in the collecting tray.

FIG. 5 is a schematic view of a processing unit for conveying information indicative of the carryback material detected by a sensor.

FIG. 6 is a flowchart showing an example method of operating the carryback collector.

FIG. 7 is a network diagram illustrating wireless communication of the carryback mat and sensor modules by way of a wireless gateway and a cloud computing system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Described herein is a carryback collector for automatically collecting, measuring, and discharging carryback material that is scraped from a belt during the return run of the belt. As described in greater detail below, the carryback collector may automatically move a scraper blade into engagement with the belt to scrape carryback from the belt (e.g., as determined by a predetermined schedule), and may automatically move the scraper blade out of engagement with the belt (e.g., after a predetermined period of time or after collecting a predetermined weight of carryback).

Carryback scraped off the is collected in a tray below the scraper blade. The carryback collector may automatically control the orientation of the tray relative to the belt. For example, the carryback collector may automatically move (e.g., rotate) the tray to a generally horizontal position during collection of carryback, and may automatically move the tray to a generally vertical position to discharge or dump the carryback material (e.g., after a predetermined period of time or after collecting a predetermined weight of carryback. The carryback collector may also include one or more sensors for weighing the carryback collected in the tray.

The carryback collector described herein may be an automatic, permanently installed system for measuring carryback without manual user intervention. More particularly, the frame of the carryback collector may be permanently installed on a ground surface. Various components of the carryback collector, including wear components such as the scraper blade, the tray, etc., may be changed out over time.

The automated carryback collector allows for belt cleaner system performance to be accurately measured and quantified on an on-going basis. The automated carryback collector further allows operators to monitor how belt cleaner performance degradation occurs with time, maintenance, and environmental factors. Additionally or alternatively, various components of the carryback collector (such as a scraper blade actuator and/or a tray actuator) may be manually controlled.

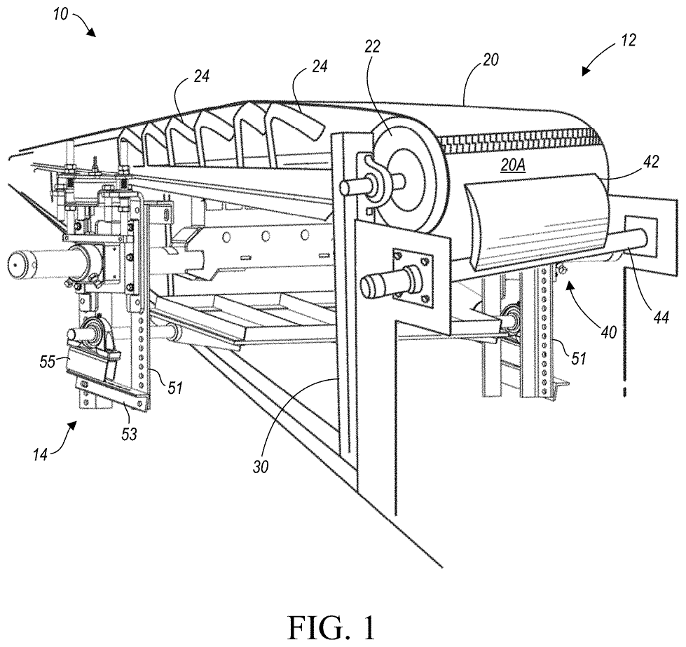

Referring to FIG. 1, a conveyor system 10 includes a conveyor belt assembly 12 and a carryback collector 14. The conveyor belt assembly 12 includes a conveyor belt 20 that extends across rollers such as drive roller 22 and idler rollers 24 that are rotatably supported by bearings mounted to a conveyor frame 30. The conveyor belt 20 is a continuous belt that extends around the drive rollers 22 and idler rollers 24 such that the conveyor belt 20 travels relative to the frame 30 along a path.

The conveyor belt system 10 further includes at least one belt cleaner 40. The belt cleaner 40 may include a scraper blade 42 biased toward the belt 20 so its upper scraping edge is urged into engagement with the outer surface 20A of the belt 20. The scraper blade 42 may be operatively mounted to an elongate support such as a support pole 44, which is rotatively biased for causing the scraper blade 42 to tightly engage the outer surface 20A of the belt 20. In the approach shown in FIG. 1, the belt cleaner 40 is a primary cleaner and is positioned proximate the drive roller 22 so as to remove material from the conveyor belt 20 as the belt 20 passes over the drive roller 22. As discussed in greater detail below, the carryback collector 14 may function as a secondary belt cleaner that is positioned along the return run of the conveyor belt 20 to provide additional cleaning of the conveyor belt 20 and to collect and measure carryback material carried by the belt 20.

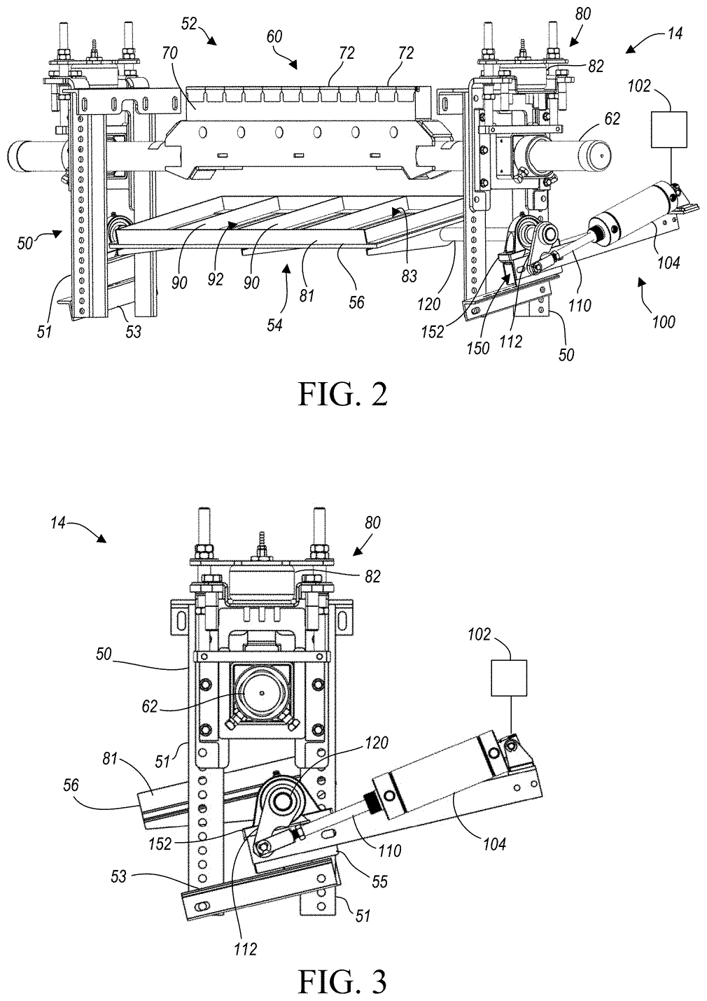

Referring to FIGS. 2 and 3, the carryback collector 14 includes a pair of frame assemblies 50 on either side of the conveyer belt 20 that support a belt cleaner 52 and a carryback accumulation or collection device 54 that includes a tray 56. As discussed in greater detail below, the carryback collector 14 automatically collects and measures carryback along a conveyor belt 20 without manual user intervention such that conveyor belt assembly performance can be accurately measured and quantified in real-time. Such monitoring of conveyor belt assembly performance can inform an operator of an operational status of one or more components such as a primary scraper blade 42 of the conveyor belt assembly 12.

The belt cleaner 52 includes a scraper blade 60 mounted to an elongate support such as a support pole 62. The scraper blade 60 may be a scraper blade assembly having an elongate body portion 70 and one or more blade tips 72 secured to the body portion 70. The body portion 70 may be of an elastomeric material such as urethane, and the blade tips 72 may be formed, for example, of steel, carbide overlay plate, tungsten carbide, or other suitable hard material for scraping carryback off of a belt 20. The scraper blade 60 preferably extends across substantially the entire width of the belt 20, or may extend across less than the entire width of the belt 20.

The carryback collector 14 includes a belt cleaner tensioner assembly 80 for automatically moving the belt cleaner 52 into and out of biased engagement with the belt 20. The belt cleaner tensioner assembly 80 may include one or more biasing members 82 for moving the scraper blade 60 into and out of engagement with the belt 20. The biasing members 82 may be spring, hydraulic, pneumatic, or other suitable biasing members. For example, the biasing member 82 may be an air bag that is pressurized or depressurized by operation of a solenoid valve. The solenoid valve may be controlled by a controller such as controller 200 discussed in greater detail below. The biasing member 82 may be controlled to maintain a desired contact pressure between the scraper blade 60 and the belt 20. As illustrated, pressurizing the air bag biasing members 82 causes the ends of the support pole 62 extending through and secured in the slidable subframe assemblies on either side of the belt to be pulled upwardly urging the scraper blade 60 into tight engagement with the conveyor belt.

The collection device 54 is mounted to be disposed below the belt cleaner 52 such that carryback scraped off the belt 20 by the belt cleaner 52 is collected in the collection device 54. As discussed, the collection device 54 may be in the form of a tray 56. The tray 56 may include a flat rectangular base with upstanding walls extending about the perimeter of the base to form a carryback collection area or space of the tray 56. The tray 56 may be of sufficient size such that the tray 56 extends along the entire width of the belt, or beyond the width of the belt (e.g., by 9 inches on either side of the belt).

In the illustrated form, the tray 56 includes one or more perimeter walls 81 that extend about a floor surface 83 of the tray 56. The tray 56 further includes one or more dividers 90 that partition the collection area of the tray 56 into receptacles defining collection area sections 92. The collection area sections 92 correspond to portions of the belt 20 across the width of the belt 20. For example, the dividers 90 may divide the tray 56 into quarters, with outer collection area sections 92A that collect carryback scraped from the outer quarter-widths of the belt 20 and inner collection sections 92B that collect carryback scraped from the inner half of the belt 20. In this way, the tray 56 retains carryback generally in the original lateral location along the width of the belt 20 as collected from the belt 20 such that an operator can visually identify the corresponding section or sections across the width of the belt 20 where most of the carryback is occurring.

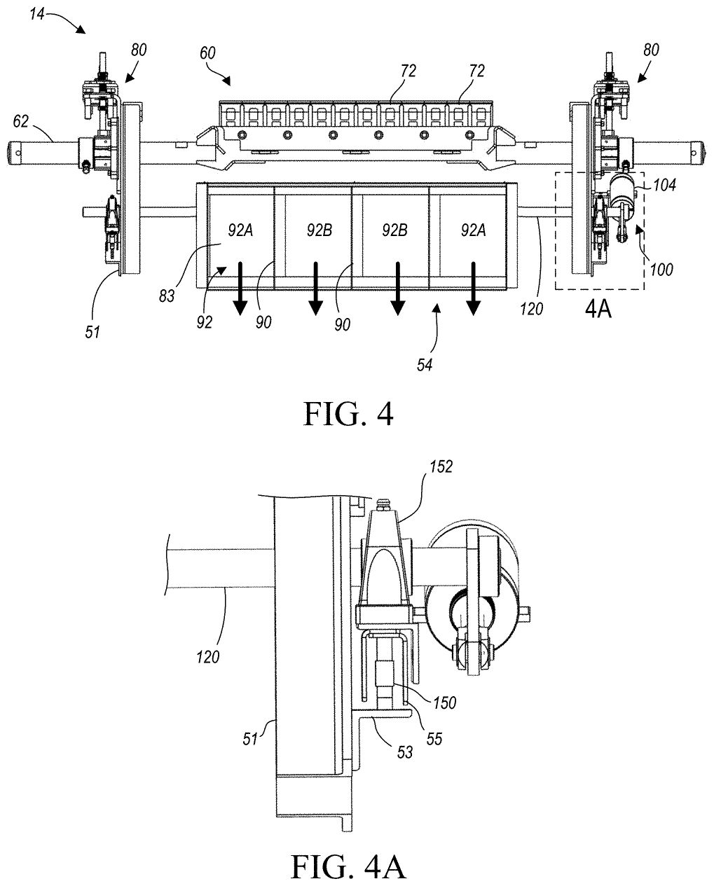

The carryback collector 14 includes one or more tray actuators 100 for moving the collection device 54 between position limits such as a generally horizontal or collection position (shown in FIGS. 1-3) for collecting carryback, and a generally vertical standby or discharge/dump position (shown in FIG. 4) for disposing the carryback. Further, it is preferred that in the dump position, the tray is rotated so that the base is tilted to be oriented beyond vertical to ensure that the contents of the tray are discharged therefrom.

The tray actuator 100 may include a motor 102 operatively connected to an actuation device 104 to actuate (e.g., reciprocate) the actuation device. The actuation device 104 can be a fluid-powered actuator such as hydraulic or pneumatic device, and may be in the form of a linear or rotary actuation device. As shown in FIGS. 2 and 3, the actuation device 104 includes an actuator arm 110 that is pivotally connected to a crank arm 112 at one end of the crank arm 112 such that actuation of the actuation device 104 rotates the crank arm 112 and a support member such as a pivot shaft 120 that is rotatably fixed to the crank arm 112 at its other end. The pivot shafts 120 are fixed to either side of the tray under the belt. Rotation of the crank arm 112 and pivot shaft 120 effects a corresponding rotation of the tray 56 to move or shift the tray between the collection position shown in FIGS. 1-3 and the standby or dump position shown in FIG. 4.

Referring to FIG. 4A, the carryback collector 14 includes one or more sensors or measurement devices such as load cells 150. The load cells 150 may be located, for example, below bearings 152, which may be pillow block bearings, that support the pivot shaft 120 of the collection device 54 at one or both sides of the pivot shaft 120. The load cells 150 may be outside of the tray 56 and beyond the side edges of the conveyor belt. In this way, the load cells 150 may be out of the fall path of carryback material that is scraped from the conveyor belt.

The load cells 150 are configured to measure carryback material, and more particularly, weight of carryback material collected in the collection device 54 for reporting to a user, as described below. For example, as carryback material accumulates on the collection device 54, the weight of the carryback material acts on the tray 56, the pivot shaft 120, and the bearings 152 that support the pivot shaft 120. The bearings 152 apply a compressive force to the load cells 150. The compressive forces cause a change in the electrical resistance of the load cell 150, which is measured as a voltage change that is proportional to the force applied. The voltage change is then converted to a digital value associated with the weight of the carryback material within the tray 54. In one example, the load cells 150 are LC103B S-Beam Load Cells sold by Omega Engineering Inc. The measurement devices may also or instead include linear encoders that use spring suspension to measure deflection.

The frame assemblies 50 include generally vertical guide rails 51 that support components of the carryback collector 14. The frame assemblies 50 support components of the belt cleaner assembly including the tensioning assembly thereof.

Each frame assembly 50 may include a transverse support member 53 that extends across the guide rails 51 to be fixed thereto in an oblique orientation to the horizontal. The transverse support members 53 each support a load cell 150 thereon. A mounting bracket 55 may extend over and be supported on the load cell 150. The mounting bracket 55 may in turn support a bearing 152 such that a compressive force imparted by the bearing 152 on the mounting bracket 55 effects a sensor reading by the load cell 150, as discussed above.

The frame assemblies 50 may also support components of the tray actuator 100. For example, at least one of the frame assemblies 50 supports an actuation device 104 including the actuator arm 110 and the crank arm 112 discussed above. In this way, the frame assemblies 50 support rotatable movement of the tray relative to the frame assemblies 50.

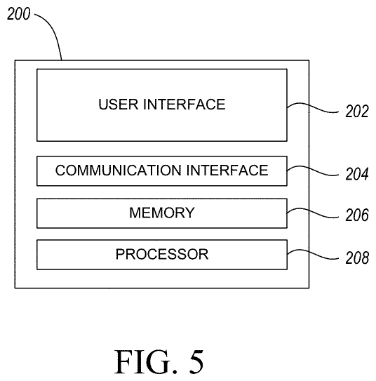

Referring to FIG. 5, a controller 200 for controlling the carryback collector 14 is shown. The controller 200 may be a local controller (e.g., located at or adjacent to the carryback collector 14) or may be a remote controller that is communicatively coupled to the carryback collector 14, or may be a combination of local and/or remote distributed controllers. The controller 200 is communicatively and/or operatively coupled to various components of the carryback collector 14. For example, the controller 200 may control actuators such as the cleaner actuator 80 and tray actuator 100, and may collect, process, and report carryback information received from the load cells 150.

The controller 200 may include a user interface 202, which may be in the form of a display such as a control screen or touchscreen display. In this way, the user interface 202 may display information pertaining to the carryback collector 14 and may receive user input for controlling the carryback collector 14.

The controller 200 may further include communication circuitry such as communication interface 204. The communication interface 204 may include an RF receiver, transmitter, or transceiver. The communication interface 204 may also or instead include a network interface such as a wired (e.g., Ethernet or LAN) or wireless (e.g., cellular, Bluetooth, or WiFi) interface for communicating over a network. In this way, the controller 200 may communicate system information such as data gathered by the load cells 150 to remote devices such as computers or servers for remote (e.g., cloud) access, or user devices such as cellular phones having an application installed thereon.

The controller 200 further includes one or more memories 206 and one or more processing units or processors 208. The memory 206 may store user inputs or system controls or programs for controlling the carryback collector 14. For example, the memory 206 may store a resettable schedule for positioning the tray in the collection position shown in FIGS. 1-3 or the standby or dump position shown in FIG. 4. The memory 206 may also store carryback information or data obtained from the load cells 150.

The processor 208 is configured to execute one or more programs stored in the memory 206 to control one or more components of the carryback collector 14. For example, the controller 200 may be electrically coupled to the belt cleaner tensioner assembly 80 and specifically an air supply for air bag tensioner members 82 such that the processor 208 selectively effects movement of the belt cleaner 52 into and out of engagement with a belt 20. The controller 200 may also be electrically coupled to the actuator 100 to control its operation such that the processor 208 selectively effects movement of the tray 56 between the collection position shown in FIGS. 1-3 and the standby or dump position shown in FIG. 4. The controller 200 may also be electrically coupled to the load cells 150 such that the processor 208 receives carryback information or data from the load cells 150.

During operation of the conveyor system 10, the controller 200 can maintain the collection device 54 in a default stand-by position such as the generally vertical position shown in FIG. 4. To initiate a carryback measurement operation, the controller 200 is operable to cause the collection device 54 to move to the collection position shown in FIGS. 1-3; for example, via actuation of actuation device 104. Movement of the collection device 54 to the collection position may be automatically controlled (e.g., according to a schedule stored in the memory 206 of the controller 200) or may be in response to a user command (e.g., as received at the user interface 202 or communication interface 204 of the controller 200).

In one example, the controller 200 moves the collection device 54 to the collection position for a predefined collection period (e.g., 10 minutes). The collection period can be set based on known parameters of the conveyor system 10 such as the type of belt being run, the width of the belt, the belt speed, and the type of material being conveyed. The predefined collection period may be set, for example, at the user interface 202 or via the communication interface 204 of the controller 200. After the collection period, the controller 200 is configured to determine and store and/or report an indication of carryback collected by the collection device 54 during the collection period; for example, as determined based on the force data obtained by the load cells 150.

With the carryback information, the controller 200 may further determine a “cleanliness” of the belt 20. For example, the controller 200 may use one or more inputs (which may be inputted by a user) such as the belt width, belt speed, carryback collection duration, and the measured carryback weight to assess belt cleanliness. The amount of carryback may be expressed, for example, in lbs/ft² or gm/m², or may be expressed as a cleanliness score. The controller 200 may assign a value or grade to the carryback assessment, such as by a numerical range of, for example, 1-7 with a grade of 7 being the most clean.

One or more of the electrical components of the carryback collector 14 (e.g., cleaner actuator 80, tray actuator 100, load cells 150, controller 200, etc.) may be powered via a plug-in interface for connecting to a power grid, or may be battery operated.

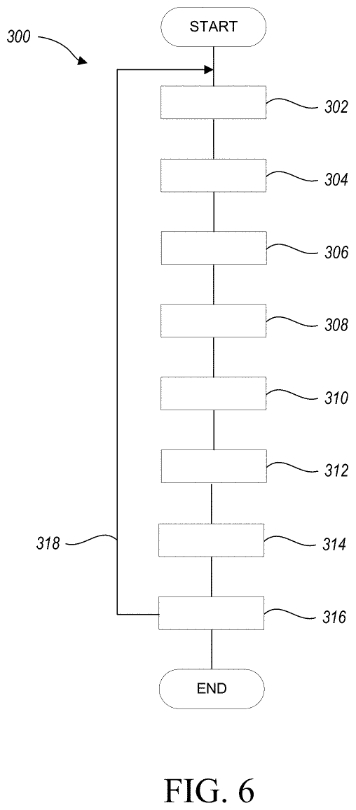

Referring to FIG. 6, a method 300 of operating a carryback collector 14 includes defining 302 one or more system parameters of the conveyor system 10. The system parameters may include one or more of the type of belt being run, the width of the belt, the belt speed, and the type of material being conveyed. The method 300 may further include inputting 304 a carryback assessment schedule. The carryback assessment schedule may include a start time, a run duration, an end time, and/or a frequency (e.g., number of assessments per day, week, month, etc.). The system parameters and/or carryback assessment schedule may be inputted at or received by the controller 200; for example, locally at the user interface 202 or remotely via the communication interface 204. The system parameters and/or carryback assessment schedule are stored in the memory 206 of the controller 200.

The method 300 includes resetting 306 or “zeroing out” a weight of the collection device 54 on the load cells 150. The resetting 306 may be performed, for example, at the controller 200 and prior to assessing carryback on the belt 20. By resetting the weight of the collection device 54 on the load cells 150, the controller 200 can account for the weight of the tray 56, pivot shaft 120, other components of the collection device 54, as well as any residual carryback left in the tray 56 that is left over from previous runs of the belt 20 to thereby isolate the weight of carryback subsequently collected on the tray 56.

As discussed, the controller 200 may maintain the tray 56 in a default, generally vertical orientation shown in FIG. 4. The method 300 further includes actuating 306 tray actuators 100 to move the tray 56 from the generally vertical position to the generally horizontal or collection position (shown in FIGS. 1-3) for collecting carryback. For example, the controller 200 of the carryback collector 14 may automatically actuate the tray actuators 100 according to the carryback assessment schedule stored in the memory 206 to rotate the tray 56 into the collection position.

The method 300 further includes actuating 308 the belt cleaner tensioner assembly 80 to cause the scraper blade 60 of the belt cleaner 52 to engage the belt 20. The belt cleaner tensioner assembly 80 may be actuated concurrently with or after actuating 306 the tray actuators 100, and may be actuated with the belt 20 running or stopped.

With the scraper blade 60 engages with the moving belt 20, the method 300 further includes accumulating 310 carryback from the belt 20. More particularly, the scraper blade 60 scrapes carryback from the belt 20 along the return run of the belt 20 such that the carryback is collected in the tray 56.

The method 300 further includes obtaining 312 a weight of the carryback received on the tray 56. The weight is determined by the controller 200 based on information detected by the load cells 150 that is obtained by the controller 200.

The method 300 further includes communicating 314 carryback information from the controller 200 to a user (e.g., locally via the user interface and/or remotely via the communication interface 204). The carryback information includes information pertaining to the carryback collected at the tray 56 and may further include information pertaining to the carryback assessment schedule. For example, the carryback information may include the weight of the carryback collected and/or the duration of the sampling. The carryback information may also include information pertaining to the location of the carryback as collected in the tray 56. For example, the controller 200 may report that an outer collection area section 92A accumulated a first amount of carryback, and that an inner collection area section 92B accumulated a second amount of carryback that may be the same as or different than the first amount. In this way, a user may assess the carryback information to determine an imbalance in material being carried along the width of the belt 20. The carryback information may be made available to a user in real-time, and may be stored in the memory 206 such that a user may access historical carryback data.

The carryback information may also or may instead include a grade assigned by the controller 200 to assess cleanliness of the belt 20 as a function of the amount of carryback collected in the tray 56. For example, the controller 200 may assign cleanliness value that may be in the form of a numerical grade such as 1-7, with “7” being the cleanest assessment and “1” being the dirtiest assessment. The carryback information may be reported to a user in real-time. In this way, a user may monitor any increases in weight of the accumulated carryback, including the location of the weight increases on the belt 20.

The method 300 further includes articulating 316 the tray 56 to dump the carryback material from the tray 56. Dumping the carryback material includes rotating the tray 56 from the generally horizontal or inclined orientation to a generally vertical orientation. By way of example, the controller 200 may cause the tray to rotate downwardly approximately 90 degrees from the collecting orientation, approximately 100 degrees, approximately 110 degrees, approximately 120 degrees, or more than 120 degrees. The controller 200 may automatically actuate the tray actuators 100 according to the carryback assessment schedule. For example, the controller 20 may dump the carryback at an end time or after the expiration of a run duration. Additionally or alternatively, the controller 20 may dump the carryback upon the weight change assessed by the load cells 150 achieving or exceeding a predetermined weight change (e.g., 10 pounds, 20 pounds, or more than 20 pounds). Dumping the carryback minimizes ancillary carryback buildup between carryback tests. The carryback may be dumped into a carryback disposal receptacle disposed below the tray 56, or may be dumped onto a floor surface.

Upon dumping 316 of the carryback, the method 300 may end, or may be repeated according the carryback assessment schedule, as indicated at 318.

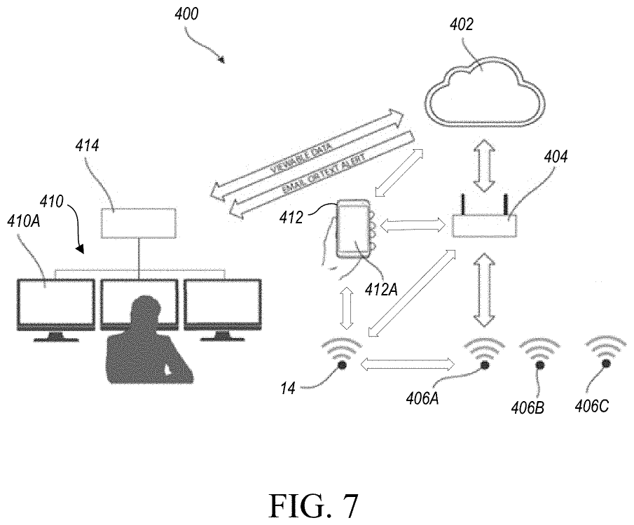

Referring to FIG. 7, the carryback collector 14 may be in communication with and monitored by a multipurpose conveyor monitoring system 400, such as the various systems disclosed in U.S. Pat. No. 10,836,585, which is incorporated by reference herein in its entirety. Such a multipurpose conveyor monitoring system 400 is able to monitor carryback on the carryback collector 14.

The monitoring system 400 may also monitor other sensor modules or sensors 406A, 406B, 406C associated with ancillary devices of the conveyor system such as splices and splice fasteners, belt scrapers, idler rollers, trackers, and/or impact beds. The sensors 406A, 406B, 406C include communication interfaces such as antennas and associated circuitry, or one of the various communication modules described above with respect to the communication interface 204 of the carryback collector 14. In some forms, the carryback collector 14 cooperates and communicates with one or more of the sensors 406A, 406B, 406C. For example, the carryback collector 14 may communicate information indicative of carryback material to one or more of the sensors 406A, 406B, 406C, which may then communicate the information to a cloud computing system 402, discussed in greater detail below.

The carryback collector 14 and sensors 406A, 406B, 406C communicate with the cloud computing system 402 by way of a gateway 404. The wireless communication between the gateway 304 and the carryback collector 14 and/or sensors 406A, 406B, 406C may utilize any of a variety of communication protocols. For example, the carryback collector 14 and/or sensors 406A, 406B, 406C may use infrastructure protocols such as 6LowPAN, IPv4/Ipv6, RPL, QUIC, Aeron, uIP, DTLS, ROLL/RPL, NanolP, CNN, and TSMP; identification protocols such as EPC, uCode, Ipv6, and URIs; communication/transport protocols such as Wifi, Bluetooth®, DigiMesh, ANT, NFC, WirelessHart, IEEE 802.15.4, Zigbee, EnOcean, WiMax, and LPWAN; discovery protocols such as Physical Web, mDNS, HyperCat, UpnP, and DNS-SD; Data protocols such as MQTT, MQTT-SN, Mosquitto, IMB MessageSight, STOMP, XMPP, XMPP-IoT, CoAP, AMQP, Websocket and Node; device management protocols such as TR-069 and OMA-DM; semantic JSON-LD and Web Thing Model; and/or multi-layer frame work protocols such as Alljoyn, IoTivity, Weave, and Homekit.

The cloud computing system 402 processes data from the carryback collector 14 to determine a characteristic of the carryback material received on the carryback collector 14. The cloud computing system 402 may also process data from one or more of the sensors 406A, 406B, 406C to determine one or more characteristics of a corresponding ancillary devices and/or conveyor belt 20, and/or to predict the remaining lifespan thereof. The cloud computing system 402 may also be operable to detect other statuses of the conveyor system 10, such as whether the conveyor belt 20 is running, how long the conveyor belt 20 has been running, how many times a splice has traveled about the conveyor system 10, whether the conveyor belt 20 is mistracking, whether an ancillary device is properly engaged with the belt 20, and the presence or absence of material on the conveyor belt 20. As is known, the cloud computing system 402 may include one or more remote servers providing cloud computing functionality.

Information from the cloud computing system 402 can be viewed by a user through a computer 410 or smartphone 412 via displays or user interfaces 410A, 412A thereof. The control system 414 may provide an operator information so that the operator can monitor or adjust the conveyor belt system 10 for proper operation thereof. The control system 414 may also allow an operator to provide inputs relating to the conveyor system 10 such as belt width, belt speed, cleaner type, carryback collection duration, and measured carryback weight. Although a desktop computer 410 and a smartphone 412 are shown in FIG. 7, other computing devices may be utilized such as a laptop computer, a tablet computer, a smartwatch, and augmented reality glasses. In this way, an operator may be informed of various characteristics of the conveyor system 10 such as a characteristic of carryback received on a carryback collector 14.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A carryback material collection system for assessing carryback material received from a conveyor belt, the carryback material collection system comprising:
a tray positionable below the conveyor belt for receiving carryback material from the conveyor belt;
at least one sensor for detecting carryback material received in the tray;
a processing unit communicatively coupled with the at least one sensor for conveying information indicative of the carryback material detected by the at least one sensor; and
a tray actuator operatively coupled to the tray to move the tray between a collection orientation to receive carryback material from the conveyor belt and a discharge orientation to discharge the carryback material from the tray.

2. The carryback material collection system of claim 1 wherein the tray includes at least one divider and distinct receptacle areas on either side of the divider that correspond to different areas across a width of the conveyor belt so that the receptacle areas retain the carryback material therein from the corresponding different areas to provide a visual indication in differences in the amount of carryback materials in each of the receptacles.

3. The carryback material collection system of claim 1 wherein the tray is generally horizontal when in the collection orientation and is rotated beyond vertical in the discharge orientation.

4. The carryback material collection system of claim 1 wherein the at least one sensor includes a first sensor outside of the tray adjacent one end thereof and a second sensor outside of the tray adjacent an opposite, second end thereof.

5. The carryback material collection system of claim 4 wherein the first sensor is disposed beyond one side of the conveyor belt and the second sensor is beyond an opposite side of the conveyor belt.

6. The carryback material collection system of claim 1 wherein the tray has a width that is sized to be the same as or greater than a width of the conveyor belt.

7. The carryback material collection system of claim 1, further comprising a side frame assembly adjacent a side of the conveyor belt and supporting a support member that is rotatably mounted to the side frame assembly and coupled to the tray, the side frame assembly further having the at least one sensor mounted thereto below the support member so that the at least one sensor is operable to measure the weight of the support member, the tray, and any of the carryback material received in the tray.

8. The carryback material collection system of claim 7 wherein the tray actuator is a fluid-powered actuator operable to rotate the rotatable member to move the tray between the collection orientation and the discharge orientation.

9. The carryback material collection system of claim 1 in combination with a belt cleaner assembly including at least one scraper blade with the tray located below the scraper blade in the collection orientation thereof, the combination further comprising an actuator operable to shift the scraper blade into and out of engagement with the conveyor belt.

10. The carryback material collection system of claim 9 wherein the scraper blade is vertically movable relative to the tray and wherein the tray is rotatably movable relative to the scraper blade.

11. A conveyor belt cleaner and material collection system for assessing carryback material received from a conveyor belt, the system comprising:
at least one scraper blade for scraping carryback material from the conveyor belt when in scraping engagement with the conveyor belt;
a tray below the scraper blade for receiving carryback material scraped from the conveyor belt by the scraper blade, the tray being configured to be shifted between a collection orientation to receive carryback material from the conveyor belt and a discharge orientation to discharge the carryback material from the tray;
at least one sensor for detecting carryback material received in the tray;
a processing unit communicatively coupled with the at least one sensor for conveying information indicative of the carryback material detected by the at least one sensor.

12. The material collection and assessment system of claim 11 further comprising a tray actuator operatively coupled to the tray to rotate the tray between the collection orientation and the discharge orientation.

13. The material collection and assessment system of claim 11 further comprising a blade actuator operable to shift the scraper blade into and out of scraping engagement with the conveyor belt.

14. The material collection and assessment system of claim 11 further comprising a side frame assembly for supporting a first support pole member to which the scraper blade is operatively mounted and a second support pole member to which the tray is operatively mounted.

15. A method for assessing carryback material from a conveyor belt, the method comprising:
positioning a tray below the conveyor belt in a collection orientation;
shifting a scraper blade into engagement with the conveyor belt above the tray;
detecting carryback material scraped from the conveyor belt by the scraper blade and received in the tray; and
conveying information based on the detected carryback material to an operator with the tray remaining below the conveyor belt.

16. The method of claim 15 further comprising:
shifting the tray from the collection orientation to a discharge orientation for discharging carryback material from the tray.

17. The method of claim 16 wherein the tray is shifted from the collection orientation to the discharge orientation automatically after a predetermined period of time during operation of the conveyor belt.

18. The method of claim 15 wherein the information conveyed by the processor includes weight of the detected carryback material, the method further comprising:
determining a value representative of a cleanliness level of the conveyor belt based at least in part on the weight of the detected carryback material and at least one of:
a belt width;
a best speed; and
a carryback material collection duration.

19. The method of claim 18 wherein the information conveyed by the processor accounts for a weight of the tray.

20. The method of claim 15 wherein detecting the carryback material scraped from the belt comprises detecting carryback material received in the tray during a first conveyor belt operation and during a second conveyor belt operation with the first conveyor belt operation and the second conveyor belt operation having different operating conditions from each other

21. The method of claim 20 wherein the scraper blade is disengaged from the conveyor belt during the first conveyor belt operation and is shifted into scraping engagement with the conveyor belt during the second conveyor belt operation; and
providing a comparative output indicative of carryback material deposited during the first and second conveyor belt operations.
